(19) United States
(12) Patent Application Publication
(10) Pub. No.: US 2005/0146892 A1
(43) Pub. Date: Jul. 7, 2005

(54) Planar light source and liquid crystal display apparatus having the same

(76) Inventors: Hae-Il Park, Seoul (KR); Sang-Yu Lee, Yongin-si (KR); Jin-Seob Byun, Seoul (KR)

Correspondence Address: CANTOR COLBURN, LLP, 55 GRIFFIN ROAD SOUTH, BLOOMFIELD, CT, 06002, US

(21) Appl. No.: 11/019,153

(22) Filed: Dec. 21, 2004

(30) Foreign Application Priority Data
Jan. 2, 2004 (KR) 2004-00027

(51) Int. Cl. F21V 7/04

(52) U.S. Cl. 362/560; 362/561

(57) ABSTRACT

In a planar light source and an LCD apparatus having the planar light source, the planar light source includes a first substrate, a second substrate, a supporting member, a connecting member, and a connecting passage. The first substrate, the second substrate, the supporting member, the connecting member, and the connecting passage are configured to define a discharge space. The second substrate is spaced apart from the first substrate. The supporting member is disposed between the first and second substrates. The connecting member is connected to the supporting member and disposed between the first and second substrates. The connecting passage is formed in the connecting member. The connecting passage provides a gas-flow path between the discharge space and an outside of the connecting member. Therefore, light emission characteristics of the planar light source are improved and a thickness of the LCD apparatus is decreased.

### BACKGROUND OF THE INVENTION

1. Field of the Invention

The present invention relates to a planar light source and a liquid crystal display (LCD) apparatus having the planar light source. More particularly, the present invention relates to a planar light source having improved light emission characteristics and decreased thickness, and an LCD apparatus having the planar light source.

2. Description of the Related Art

LCD apparatuses, in general, display images using liquid crystal and area type of flat panel display. The LCD apparatuses have various characteristics including, for example, thin thickness, low driving voltage, low power consumption, etc. The LCD apparatuses have been widely used owing to such advantageous characteristics.

The LCD apparatuses are also a type of non-emissive display necessitating a light source such as a backlight assembly. A conventional backlight assembly is classified into either an edge illumination type backlight assembly or a direct illumination type backlight assembly.

In the edge illumination type backlight assembly, one or more lamps are disposed on edge portions of a light guide plate having a reflecting layer to supply an LCD panel with light. In the direct illumination type backlight assembly, lamps are disposed under a light guide plate. A reflection plate and a diffusion plate are disposed under the direct illumination type backlight assembly and on the light guide plate, respectively, to supply an LCD panel with light. The direct illumination type backlight assembly generates light having a high luminance, however, the light generated from the direct illumination type backlight assembly may be non-uniform. The edge illumination type backlight assembly is thinner and lighter than the direct illumination type backlight assembly. However, the edge illumination type backlight assembly has lower luminance than that of the direct illumination type backlight assembly.

The backlight assembly includes a cold cathode fluorescent lamp (CCFL) or a light emitting diode (LED). The CCFL has a cylindrical shape, and the LED has a dot shape. Characteristics of the CCFL include, for example, a high luminance, a long lifetime, etc. The CCFL generates less heat than an incandescent lamp. Characteristics of the LED include, for example, a small size, a low power consumption, etc. However, the backlight assembly having the CCFL or the LED has lower luminance and less uniform luminance than a planar light source.

The backlight assembly having the CCFL or the LED includes optical members to increase the luminance and to uniformize the luminance. The optical members are additional components which may increase size, weight, and manufacturing cost of the LCD apparatus. The optical members may include a light guide plate (LGP), a diffusion member and a prism sheet, etc.

A planar light source has been developed to solve the above-mentioned problems. The planar light source includes a lamp body and electrodes. The lamp body includes a discharge space having discharge portions disposed adjacent to one another. A discharge voltage is applied to the lamp body through the electrodes. The discharge portions are connected to one another so that a distribution of discharge gas in the discharge portions may be uniformized. The discharge voltage is applied to the electrodes to generate a plasma discharge in the discharge space to generate the light.

When the plasma discharge is generated in the discharge space, current may flow through the discharge portions so that a voltage drop is formed in each discharge portion. The amount of the voltage drop is substantially equal to the current multiplied by a square of a resistance of each discharge portion. The resistances of the discharge portions are different from each other so that the voltage drops of the discharge portions are different from each other. The difference of the voltage drops form a potential difference between the discharge portions so that a portion of the current may concentrate on one discharge portion, thereby forming a channeling of the current. The channeling of the current deteriorates both the luminance and the uniformity of the luminance. Additionally, an image display quality of the LCD apparatus employing such planar light source may be decreased.

### SUMMARY OF THE INVENTION

The present invention provides a planar light source having improved light emission characteristics and decreased thickness.

The present invention also provides an LCD apparatus having the above-mentioned planar light source.

A planar light source in accordance with an exemplary embodiment of the present invention includes a first substrate, a second substrate, a supporting member and a connecting member. The first substrate, the second substrate, the supporting member, the connecting member, and the connecting passage are configured to define a discharge space. The first substrate is spaced apart from the second substrate by a predetermined distance. The supporting member is disposed between the first and second substrates so that the first substrate is spaced apart from the second substrate. The connecting member is connected to the supporting member between the first and second substrates. The planar light source includes a connecting passage formed in the connecting member. The connecting passage provides a gas-flow path between the discharge space and outside of the connecting member.

An LCD apparatus in accordance with an exemplary embodiment of the present invention includes a planar light source, an LCD panel and a receiving container. The planar light source includes a lamp body having a discharge space and a connecting member. The connecting member has a cavity extending along an interior portion of the connecting member. The cavity allows gas to flow into and from the discharge space through the connecting member. The LCD panel displays an image using light generated from the planar light source. The receiving container receives the planar light source and the LCD panel.

According to the present invention, a channeling formed by a crosstalk between discharge portions of the discharge space is prevented so that light emission characteristics of the planar light source are improved and a thickness of the LCD apparatus is decreased.

The present application claims priority from Korean Patent Application No. 2004-27, filed on Jan. 2, 2004, the disclosure of which is hereby incorporated herein by reference in its entirety.

### BRIEF DESCRIPTION OF THE DRAWINGS

The above and other advantages of the present invention will become more apparent by describing in detail exemplary embodiments thereof with reference to the accompanying drawings, in which:

FIG. 1 is an exploded perspective view showing a planar light source in accordance with an exemplary embodiment of the present invention;

FIG. 2 is an exploded perspective view showing a planar light source in accordance with another exemplary embodiment of the present invention;

FIG. 3 is a cross-sectional view taken along a first direction of the planar light source shown in FIG. 2;

FIG. 4 is a cross-sectional view taken along a second direction of the planar light source shown in FIG. 2;

FIG. 5 is a perspective view showing a connecting member shown in FIG. 2;

FIG. 6 is a perspective view showing a connecting member in accordance with another exemplary embodiment of the present invention;

FIG. 7 is a cross-sectional view showing the connecting member shown in FIG. 6;

FIG. 8 is a cross-sectional view showing a connecting member in accordance with another exemplary embodiment of the present invention;

FIG. 9 is a partially cutout perspective view showing a planar light source having electrodes in accordance with another exemplary embodiment of the present invention;

FIG. 10 is an exploded perspective view showing a planar light source in accordance with another exemplary embodiment of the present invention;

FIG. 11 is a cross-sectional view taken along a first direction of the planar light source shown in FIG. 10;

FIG. 12 is a plan view showing the planar light source shown in FIG. 10;

FIG. 13 is an exploded perspective view showing a planar light source in accordance with another exemplary embodiment of the present invention;

FIG. 14 is a plan view showing the planar light source shown in FIG. 13; and

FIG. 15 is an exploded perspective view showing an LCD apparatus in accordance with an exemplary embodiment of the present invention.

### DESCRIPTION OF THE EMBODIMENTS

It should be understood that the exemplary embodiments of the present invention described below may be modified in many different ways without departing from the inventive principles disclosed herein, and the scope of the present invention is therefore not limited to these particular following embodiments. Rather, these embodiments are provided so that this disclosure will be thorough and complete, and will fully convey the concept of the invention to those skilled in the art by way of example and not of limitation.

Hereinafter, the present invention will be described in detail with reference to the accompanying drawings.

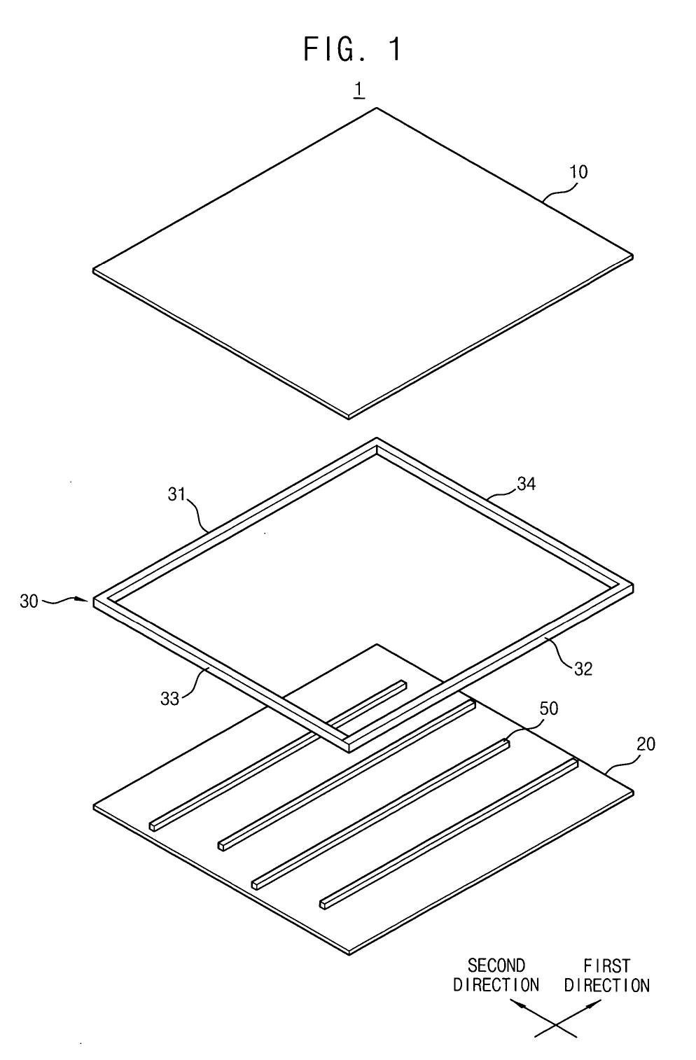

FIG. 1 is an exploded perspective view showing a planar light source in accordance with an exemplary embodiment of the present invention.

Referring to FIG. 1, the planar light source 1 includes a first substrate 10, a second substrate 20, a supporting member 30 and one or more space dividing members 50. In this embodiment, the planar light source 1 includes a plurality of the space dividing members 50. The first substrate 10, the second substrate 20 and the supporting member 30 define a discharge space. The supporting member 30 includes a first sidewall 31, a second sidewall 32 disposed substantially parallel to the first sidewall 31, a third sidewall 33 and a fourth sidewall 34 disposed substantially parallel to the third sidewall 33. First, second, third, and fourth sidewalls 31, 32, 33, and 34 each have a first end and a second end. The first end of the third sidewall 33 is connected to the first end of the first sidewall 31. The second end of the third sidewall is connected to the first end of the second sidewall 32. The first end of the fourth sidewall 34 is connected to the second end of the first sidewall 31. The second end of the fourth sidewall 34 is connected to the second end of the second sidewall 32.

Each space dividing member 50 is disposed substantially parallel to each other space dividing member 50 so that the discharge space is divided into discharge portions. Each space dividing member 50 is extended in a first direction, and arranged in a second direction that is substantially perpendicular to the first direction. Each space dividing member 50 includes a first end portion and a second end portion. The space dividing members 50 are numbered sequentially from the space dividing member 50 disposed closest to the second sidewall 32 to the space dividing member 50 closest to the first sidewall 31. The first end portion of each even numbered space dividing member 50 makes contact with a portion of the third sidewall 33. The second end portion of each even numbered space dividing member 50 is spaced apart from the fourth sidewall 34. The first end portion of each odd numbered space dividing member 50 makes contact with the fourth sidewall 34, and the second end portion of each odd numbered space dividing member 50 is spaced apart from the third sidewall 33. Therefore, the space dividing members 50 are arranged in an alternating arrangement so that the discharge space has a serpentine shape.

The planar light source 1 further includes electrodes (not shown). The electrodes (not shown) are alternatively disposed in the discharge space, or on the first substrate 10 or on the second substrate 20. When a discharge voltage that is provided from an exterior to the planar light source 1 is applied to the electrodes (not shown), plasma is generated in the discharge space.

The planar light source 1 optionally further includes a fluorescent layer (not shown) and a reflecting layer (not shown). The fluorescent layer (not shown) is disposed on a bottom surface of the first substrate 10 and an upper surface of the second substrate 20 to generate visible light based on ultraviolet light generated from the discharge space. The reflecting layer (not shown) is disposed between the second substrate 20 and the fluorescent layer (not shown) so that the visible light is reflected from the reflecting layer (not shown).

The planar light source 1 optionally further includes a connecting tube (not shown). Air may be exhausted from the discharge space through the connecting tube (not shown), and a discharge gas may be injected into the discharge space through the connecting tube (not shown). The connecting tube (not shown) includes an exhaust tube, an injection tube, etc. The connecting tube (not shown) makes contact with an opening formed at the first substrate 10 or the second substrate 20. After the air is exhausted from the discharge space and the discharge gas is injected into the discharge space, the connecting tube (not shown) may be removed from the opening. When the connecting tube (not shown) is removed, the opening may be filled with a filling material such as synthetic resin, glass, etc.

When the second end portion of the respective space dividing members 50 is spaced apart from the third sidewall 33 or the fourth sidewall 34, a crosstalk may be formed between the discharge portions disposed adjacent to the second end portion, thereby forming channeling. In other words, electric charges are concentrated adjacent to the second end portions of the space dividing members 50 so that the discharge is non-uniformly distributed in the discharge space. As a result, the uniformity of light provided by the planar light source 1 is deteriorated.

In order to uniformize the luminance of the planar light source 1, the electrodes (not shown) are optionally spaced apart from each end portion of the planar light source 1. When the electrodes (not shown) are spaced apart from each end portion of the planar light source 1 and overlapped with each space dividing member 50, the channeling may be decreased. However, when the electrodes (not shown) are overlapped with each space dividing member 50, a distance between the electrodes (not shown) is decreased causing a size of an effective light emitting surface to be decreased. In addition, when the planar light source 1 includes the connecting tube (not shown), a thickness of the planar light source 1 may be increased.

According to this exemplary embodiment, the luminance of the planar light source 1 is uniformized.

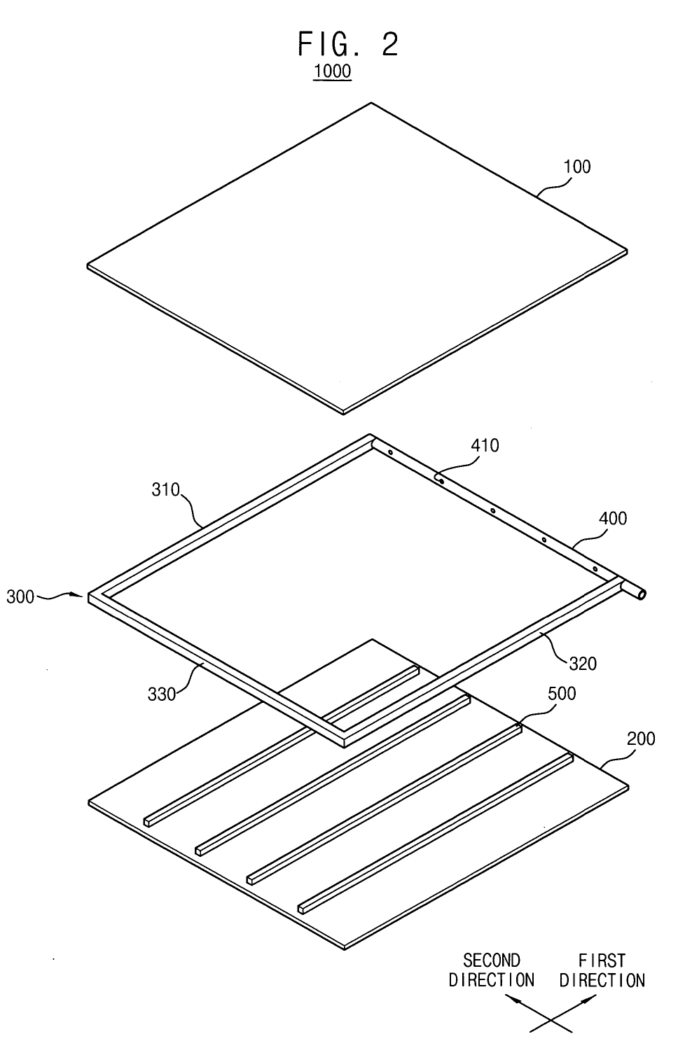

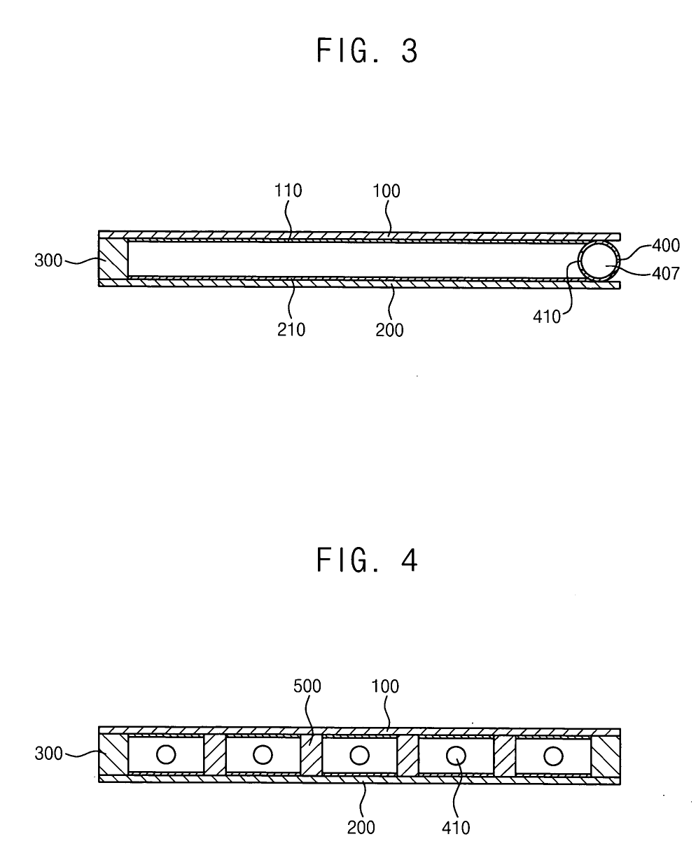

FIG. 2 is an exploded perspective view showing a planar light source in accordance with another exemplary embodiment of the present invention. FIG. 3 is a cross-sectional view taken along a first direction of the planar light source shown in FIG. 2. FIG. 4 is a cross-sectional view taken along a second direction of the planar light source shown in FIG. 2.

Referring to FIGS. 2 to 4, the planar light source 1000 includes a first substrate 100, a second substrate 200, a supporting member 300 and a connecting member 400.

The first and second substrates 100 and 200 include glass plates. Visible light may pass through the glass plates, but invisible light may not pass through the glass plates. The first substrate 100 is spaced apart from the second substrate 200, and the first substrate 100 is disposed substantially parallel to the second substrate 200. In this exemplary embodiment, the second substrate 200 is about three times thicker than the first substrate 100. Although the second substrate 200 is about three times thicker than the first substrate 100 in this embodiment, other relationships between thickness of the second substrate 200 and the first substrate 100 are also envisioned, for example, the second substrate 200 may have substantially equal thickness to the first substrate 100.

The supporting member 300 is disposed between the first and second substrates 100 and 200 to be in contact with three corresponding edges of the first and second substrates 100 and 200. The first substrate 100 is spaced apart from the second substrate 200 by the supporting member 300. The supporting member 300 includes a first sidewall 310, a second sidewall 320 opposing the first sidewall 310, and a third sidewall 330. The first, second, and third sidewalls 310, 320, and 330 each have a first end and a second end. The first end of the third sidewall is connected to the first end of the first sidewall 310. The second end of the third sidewall is connected to the first end of the second sidewall 320. The first sidewall 310 is substantially parallel to the second sidewall 320. The third sidewall 330 is disposed substantially perpendicular to the first and second sidewalls 310 and 320. In other words, the third sidewall 330 has a longitudinal direction substantially perpendicular to the longitudinal directions of the first and second sidewalls 310 and 320. The supporting member 300 optionally includes a same material as the first and second substrates 100 and 200. In other words, the supporting member 300 optionally includes the glass.

The connecting member 400 is disposed between the first and second substrates 100 and 200. The connecting member 400 is disposed substantially parallel to the third sidewall 330. The connecting member has a first end and a second end. Each end of the connecting member 400 is respectively connected to the second ends of the first and second sidewalls 310 and 320 to form a discharge space. In other words, the first substrate 100, the second substrate 200, the supporting member 300 and the connecting member 400 enclose the discharge space.

In this embodiment, a cavity is formed in the connecting member 400 so that air or discharge gas may pass through the cavity. In this embodiment, the cavity is a connecting passage 407. The connecting passage 407 provides a gas-flow path between the discharge space and an outside of the connecting member 400. The connecting member 400 optionally includes the same material as the first and second substrates 100 and 200. In other words, the connecting member 400 is optionally made of glass.

Referring to FIG. 4, an orifice 410 is formed at a selected position of the connecting member 400. In this embodiment, as shown in FIG. 4, multiple orifices are formed at selected positions of the connecting member 400. Air may be exhausted from the discharge space and the discharge gas may be injected into the discharge space through the orifices 410 and the connecting passage 407. The discharge gas may include mercury (Hg), neon (Ne), etc. The discharge gas may further include argon (Ar), krypton (Kr), xenon (Xe), etc., for penning effect to decrease a discharge voltage of the discharge space.

The connecting member 400 is disposed between corresponding sides of the first and second substrates 100 and 200. The connecting member 400, the first and second substrates 100 and 200, and the supporting member 300 combine to form the discharge space. Air may be exhausted from the discharge space through the connecting member 400, and the discharge gas may be injected into the discharge space through the connecting member 400.

The planar light source 1000 further includes a space dividing member 500. In the embodiment of FIG. 2, the planar light source 1000 includes a plurality of space dividing members 500. Each space dividing member 500 is disposed between the first and second substrates 100 and 200 in the discharge space so that the discharge space is divided into discharge portions. Each space dividing member 500 is aligned substantially parallel to each other. Each space dividing member 500 is extended in a first direction. An upper portion and a lower portion of each space dividing member 500 makes contact with the first and second substrates 100 and 200, respectively. A first end portion and a second end portion of each space dividing member 500 make contact with corresponding portions of the supporting member 300 and the connecting member 400, respectively, so that the supporting member 300, the connecting member 400 and each space dividing member 500 define the respective discharge portions. The discharge portions may be substantially isolated from one another.

Referring to FIG. 4, each orifice 410 corresponds to each discharge portion so that the air may be exhausted from each discharge portion through the corresponding orifice 410, and the discharge gas may be injected into each discharge portion through the corresponding orifice 410.

Referring to FIG. 3, the planar light source 1000 further includes a first fluorescent layer 110 and a second fluorescent layer 210. The first and second fluorescent layers 110 and 210 are formed on a lower surface of the first substrate 100 and an upper surface of the second substrate 200, respectively. The first and second fluorescent layers 110 and 210 may be formed as thin film shapes. The first and second fluorescent layers 110 and 210 are not formed, for example, on portions of the first and second substrates 100 and 200 corresponding to the electrodes (not shown). In another embodiment, the first and second fluorescent layers 110 and 210 may be extended into a side surface of the supporting member 300, a side surface of the connecting member 400 or side surfaces each space dividing member 500. The first and second fluorescent layers 110 and 210 generate visible light from ultraviolet light generated from plasma formed in the discharge space.

The planar light source 1000 may further include a reflecting layer (not shown) between the second substrate 200 and the second fluorescent layer 210. A portion of the visible light is reflected from the reflecting layer (not shown) so that the reflected light is guided toward the second substrate 200.

The planar light source 1000 may further include a first protecting layer (not shown) and a second protecting layer (not shown). The first protecting layer (not shown) is disposed between the first substrate 100 and the first fluorescent layer 110. The second protecting layer (not shown) is disposed between the second substrate 200 and the reflecting layer (not shown). The first protecting layer prevents a chemical reaction between mercury of the discharge gas and the first substrate 100. The second protecting layer prevents a chemical reaction between mercury of the discharge gas and the second substrate 200.

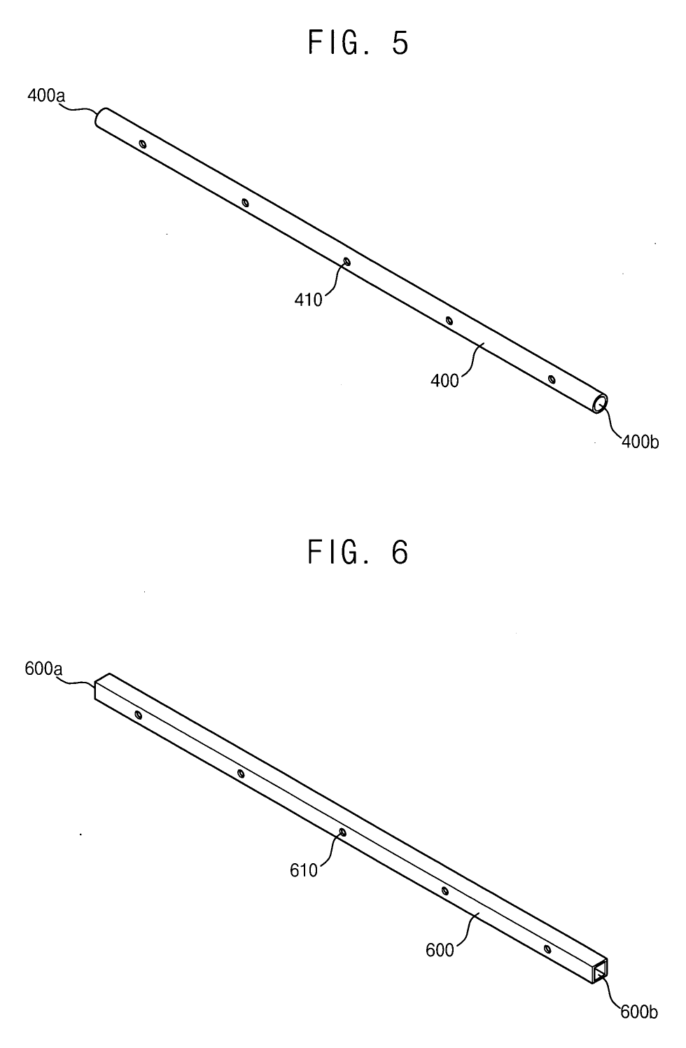

FIG. 5 is a perspective view showing the connecting member 400 shown in FIG. 2.

Referring to FIG. 5, the connecting member 400 has a cylindrical shape including a cavity therein. Although in this exemplary embodiment the cavity is disposed at the longitudinal axis of the connecting member 400 and the cavity extends over the length of the connecting member 400, it is envisioned that the cavity could be disposed in other arrangements, such as, for example, extending over a portion of the length of the connecting member 400. The cavity is a connecting passage. A closed end portion 400a of the connecting member 400 is closed. An open end portion 400b of the connecting member 400 is opened when the air is exhausted or the discharge gas is injected. A portion of the open end portion 400b extending past the intersection of the connecting member 400 and the second sidewall 320 is removed, and an opening of the open end portion 400b is then filled with a filling material, such as synthetic resin, glass, etc. The above removal of the portion of the open end portion 400b and filling with the filling material may be performed upon completion of the air exhaustion or the injection of the discharge gas.

The orifices 410 are each disposed at a selected position of the connecting member 400. For example, each orifice 410 corresponds to each discharge portion. In another embodiment, multiple orifices 410 may be disposed corresponding to one discharge portion. The discharge space is divided into the discharge portions by each space dividing member 500. Therefore, the air is exhausted from each discharge portion through each orifice 410, and the discharge gas is injected into each discharge portion through each orifice 410.

A thermally curable material is coated on the connecting member 400. The connecting member 400 makes contact with the first and second substrates 100 and 200. The coated thermally curable material is then heated so that the connecting member 400 is fixed to the first and second substrates 100 and 200.

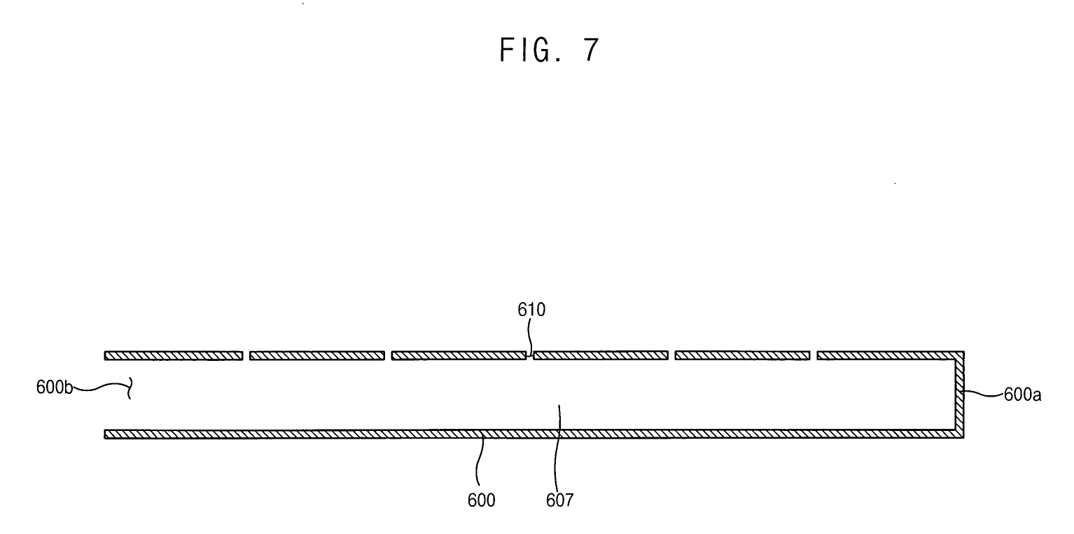

FIG. 6 is a perspective view showing a connecting member of a planar light source in accordance with another exemplary embodiment of the present invention. FIG. 7 is a cross-sectional view showing the connecting member shown in FIG. 6. The connecting member 600 in FIGS. 6 to 7 may be employed in the planar light source in FIG. 2 by replacing the connecting member 400.

Referring to FIGS. 6 and 7, the connecting member 600 has a rectangular cross-section and includes a cavity therein. The cavity is a connecting passage 607. A closed end portion 600a of the connecting member 600 is closed. An open end portion 600b of the connecting member 600 is opened when air is exhausted or a discharge gas is injected. A portion of the open end portion 600b extending past the intersection of the connecting member 600 and from the second sidewall 320 is removed, and an opening of the open end portion 600b is then filled with a filling material, for example, synthetic resin, glass, etc. The above removal of the portion of the open end portion 600b and filling with the filling material may be performed upon completion of the air exhaustion or the injection of the discharge gas.

An orifice 610 is disposed at a selected position of the connecting member 600. In this embodiment, multiple orifices 610 are each disposed at a selected position of the connecting member 600. Each orifice 610 provides a gas flow path between each discharge portion and the connecting passage 607.

According to this exemplary embodiment, the connecting member 600 has the rectangular cross-section so that the connecting member 600 is more securely fixed to the first and second substrates 100 and 200 than a connecting member having a circular cross-section.

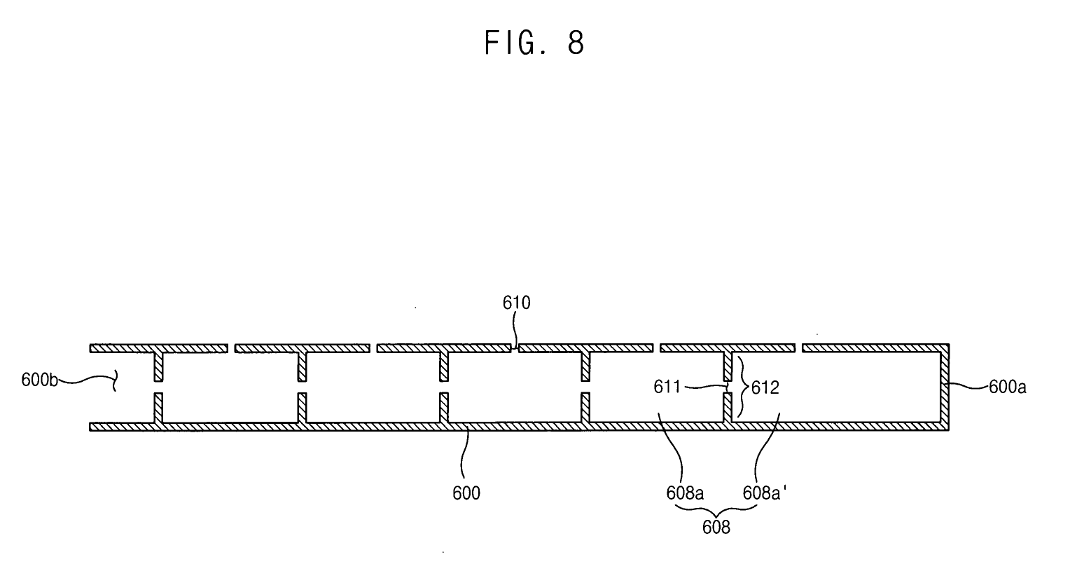

FIG. 8 is a cross-sectional view showing a connecting member of a planar light source in accordance with another exemplary embodiment of the present invention. The planar light source of the present invention may employ the connecting member 600 shown in FIG. 8.

Referring to FIG. 8, the connecting member 600 has a rectangular cross-section and includes a cavity therein. The cavity is a connecting passage 608. A closed end portion 600a of the connecting member 600 is closed. An open end portion 600b of the connecting member 600 is opened when air is exhausted or discharge gas is injected. A portion of the open end portion 600b extending past the intersection of the connecting member 600 and the second sidewall 320 is removed, and an opening of the open end portion 600b is then filled with a filling material, such as synthetic resin, glass, etc. The above removal of the portion of the open end portion 600b and filling with the filling material may be performed upon completion of the air exhaustion or the injection of the discharge gas.

Orifices 610 are disposed at selected positions in the connecting member 600. Each orifice 610 is disposed to provide a gas flow path between the connecting passage 608 and a corresponding discharge portion. In other words, the connecting passage 608 is connected to the discharge space via the orifices 610.

The connecting member 600 further includes a segmental wall 612 disposed inside the connecting member 600. In this embodiment, the connecting member 600 includes a plurality of segmental walls 612. The segmental wall 612 divides the connecting passage 608 into connecting segments 608a and 608a′. Each segmental wall 612 includes a throughhole 611. The connecting segments 608a and 608a′ are connected to one another via the throughhole 611.

According to this exemplary embodiment, the segmental wall 612 having the throughhole 611 prevents a rapid movement of plasma formed by the discharge gas, thereby uniformizing a luminance of the light provided by the planar light source 1000.

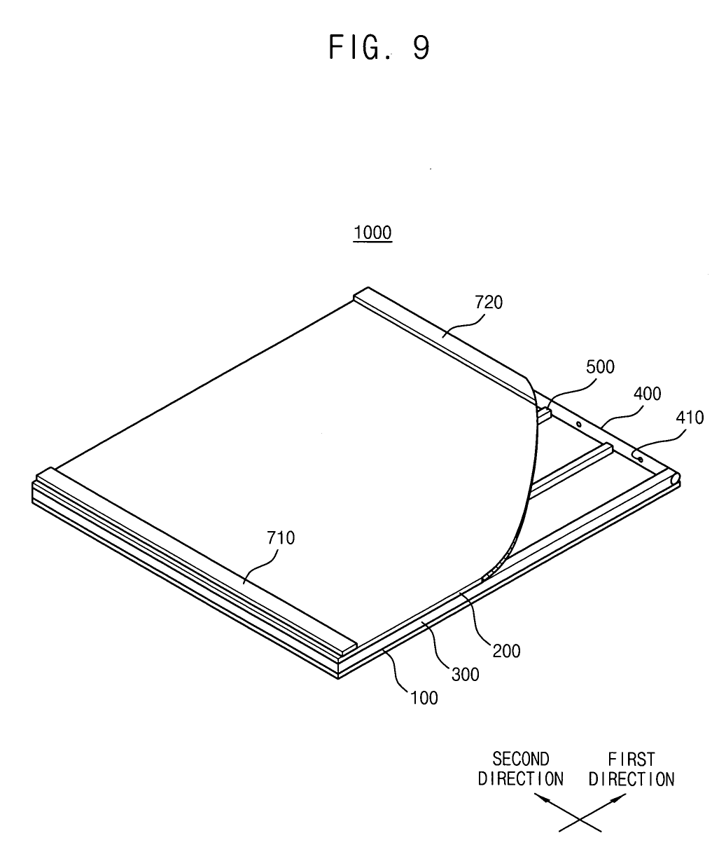

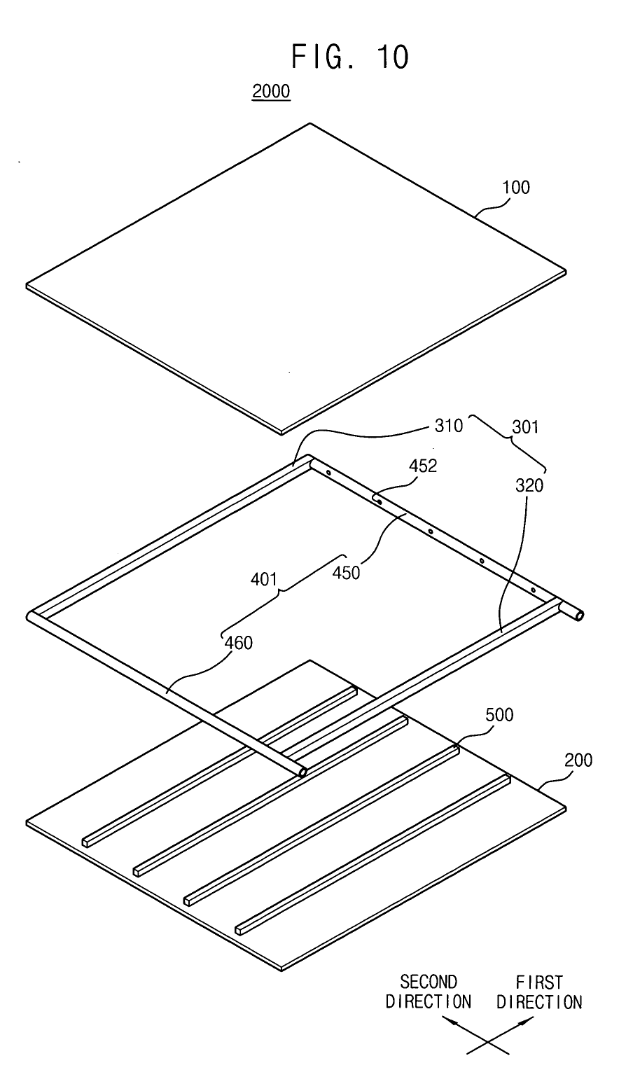

FIG. 9 is a partially cut out perspective view showing a planar light source having electrodes in accordance with another exemplary embodiment of the present invention. The planar light source shown in FIG. 9 is same as shown in FIGS. 2 to 5 except the electrodes. Thus, the same reference numerals will be used to refer to the same or like parts as those described in FIGS. 2 to 5 and any further explanation will be omitted.

Referring to FIG. 9, the planar light source 1000 includes a first electrode 710 and a second electrode 720. A discharge voltage is applied to the first and second electrodes 710 and 720.

The first and second electrodes 710 and 720 are extended in a direction (i.e. the second direction) substantially perpendicular to a longitudinal direction (i.e. the first direction) of each space dividing member 500. The first and second electrodes 710 and 720 are disposed on opposite end portions of the second substrate 720. In this exemplary embodiment, the first and second electrodes 710 and 720 are formed on an outer surface of the second substrate 200. Alternatively, the first and second electrodes 710 and 720 may be formed on an outer surface of the first substrate 100. In another embodiment, the first and second electrodes 710 and 720 may surround the end portions of the first and second substrates 100 and 200. In further another embodiment, the first and second electrodes 710 and 720 may be formed on an inner surface of the first substrate 100 or the second substrate 200.

The first and second electrodes 710 and 720 include a conductive material, for example, copper (Cu), nickel (Ni), aluminum (Al), silver (Ag), etc. as a form of metal tape or metal paste. A size of the first and second electrodes 710 and 720 is adjusted so that a sufficient electric energy is transmitted into the discharge space.

The first and second electrodes 710 and 720 are overlapped with opposite end portions of each space dividing member 500. The opposite end portions of each space dividing member 500 are connected to the supporting member 300 and the connecting member 400, respectively, so as to form discharge portions that are separated from one another by each space dividing member 500. Thus, a channeling formed between the discharge portions is effectively prevented, although the first and second electrodes 710 and 720 are disposed on the end portions of the second substrate 200. Therefore, a size of an effective light emitting surface defined between the first and second electrodes 710 and 720 is increased.

In operation, discharge voltages having a discharge start voltage and a discharge maintain voltage are applied to the first and second electrodes 710 and 720, in sequence. For example, in order to start a discharge in the discharge space, an alternating current voltage having a level of about one kilovolt to about two kilovolts is applied to the first electrode 710 during a discharge start period, and another alternating current voltage that has an opposite phase to the alternating current voltage applied to the first electrode 710 is applied to the second electrode 720 during the discharge start period, thereby generating a plasma discharge in the discharge space. The plasma discharge may be generated in a portion of the discharge space. An amplitude of the alternating current voltage applied to the first electrode 710 is substantially equal to that of the alternating current voltage applied to the second electrode 720 during the discharge start period. In order to maintain the plasma discharge, an alternating current voltage having a level of about six hundred volts to about seven hundred volts is applied to the first electrode 710 after the discharge start period, and another alternating current voltage that has an opposite phase to the alternating current voltage applied to the first electrode 710 is applied to the second electrode 720 after the discharge start period, thereby maintaining the plasma discharge in the discharge space. The plasma discharge is formed in substantially all the discharge space. An amplitude of the alternating current voltage applied to the first electrode 710 is substantially equal to that of the alternating current voltage applied to the second electrode 720 after the discharge start period.

A getter (not shown) may be disposed adjacent to an end portion of the connecting member 400 to supply the discharge space with a mercury gas. When the getter (not shown) is heated by a radio frequency radiation that is provided from an exterior to the planar light source 1000, the getter (not shown) generates the mercury gas. The mercury gas generated from the getter (not shown) is injected into the discharge space through the orifices 410 of the connecting member 400. The getter (not shown) may be removed after the mercury gas is injected into the discharge space.

According to this exemplary embodiment, the mercury gas generated from the getter (not shown) is injected into the discharge gas through the connecting member 400 so that an additional member for injecting the mercury gas is unnecessary. Therefore, a thickness of the planar light source 1000 may be decreased.

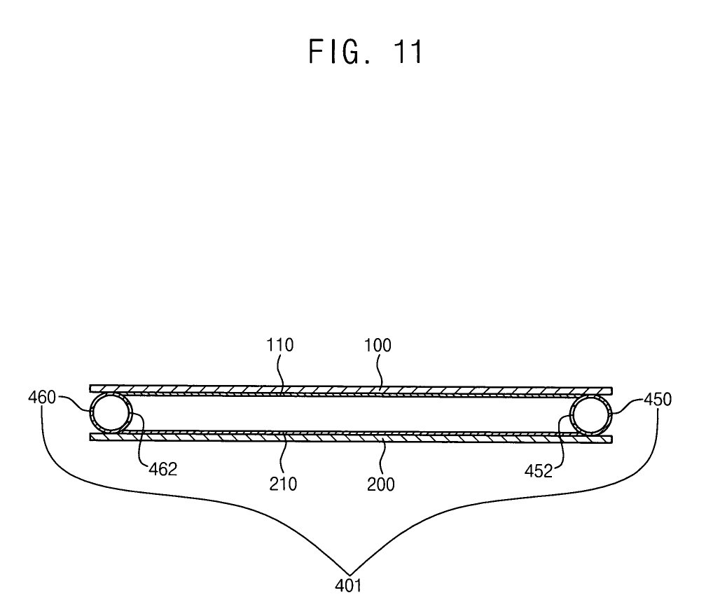

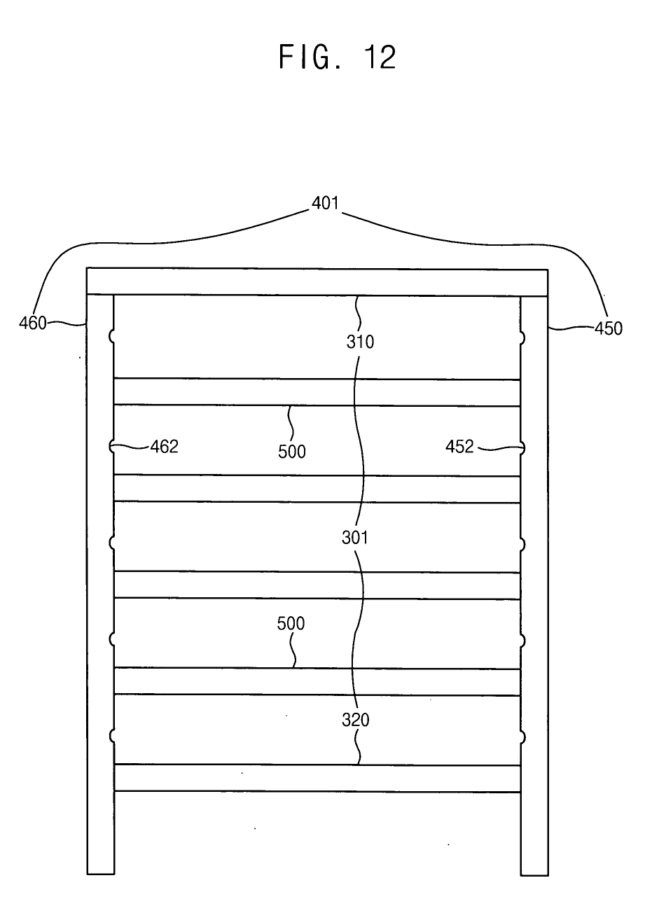

FIG. 10 is an exploded perspective view showing a planar light source in accordance with another exemplary embodiment of the present invention. FIG. 11 is a cross-sectional view taken along a first direction of the planar light source shown in FIG. 10. FIG. 12 is a plan view showing the planar light source shown in FIG. 10. The planar light source shown in FIGS. 10 to 12 is same as shown in FIGS. 2 to 5 with the exception of a supporting member and a connecting member. Thus, the same reference numerals will be used to refer to the same or like parts as those described in FIGS. 2 to 5 and any further explanation will be omitted.

Referring to FIGS. 10 to 12, the planar light source 2000 includes a first substrate 100, a second substrate 200, a supporting member 301, a connecting member 401 and a space dividing member 500. In this embodiment, the planar light source 2000 includes a plurality of the space dividing members 500. The first substrate 100 is disposed opposing the second substrate 200. The supporting member 301 is disposed between the first and second substrates 100 and 200. The connecting member 401 is disposed between the first and second substrates 100 and 200.

The supporting member 301 includes a first sidewall 310 and a second sidewall 320 spaced apart from the first sidewall 310. The first sidewall 310 is disposed substantially parallel to the second sidewall 320. The first and second sidewalls 310 and 320 each have a first end and a second end. Each space dividing member 500 is substantially parallel to the first and second sidewalls 310 and 320. The first and second sidewalls 310 and 320 and the space dividing members 500 are each extended in a first direction.

The connecting member 401 includes a first connecting tube 450 and a second connecting tube 460. The first and second connecting tubes 450 and 460 each have a first end and a second end. The first end of the first connecting tube 450 is connected to the first end of the first sidewall 310. The second end of the first connecting tube 450 is connected to the first end of the second sidewall 320. The first end of the second connecting tube 460 is connected to the second end of the first sidewall 310. The second end of the second connecting tube 460 is connected to the second end of the second sidewall 320. The first and second connecting tubes 450 and 460 are extended in a second direction substantially perpendicular to the first direction. In other words, the first connecting tube 450 is substantially parallel to the second connecting tube 460. The first and second connecting tubes 450 and 460 are substantially perpendicular to the first and second sidewalls 310 and 320. The first and second connecting tubes 450 and 460 are also substantially perpendicular to each space dividing member 500. The first and second substrates 100 and 200, the first and second sidewalls 310 and 320, and the first and second connecting tubes 450 and 460 are assembled as described above to define the discharge space. The discharge space may be closed.

The first and second connecting tubes 450 and 460 have the circular cross-sections as shown in FIG. 11. In another embodiment, the first and second connecting tubes 450 and 460 may have the rectangular cross-section similar to the connecting member 600 as shown in FIG. 6.

A first orifice 452 is disposed at a selected position of the first connecting tube 450. A second orifice 462 is disposed at a selected position of the second connecting tube 460. In this embodiment, multiple first orifices 452 and multiple second orifices 462 are disposed at selected positions of the first and second connecting tubes 450 and 460, respectively. Each first orifice 452 of the first connecting tube 450 corresponds to a respective discharge portion of the discharge space. Each second orifice 462 of the second connecting tube 460 corresponds to a respective discharge portion of the discharge space.

According to this exemplary embodiment, the planar light source 2000 includes the two connecting tubes, the first connecting tube 450 and the second connecting tube 460, so that air may be easily exhausted from the discharge space through the connecting member 401 and a discharge gas may be easily injected into the discharge space through the connecting member 401.

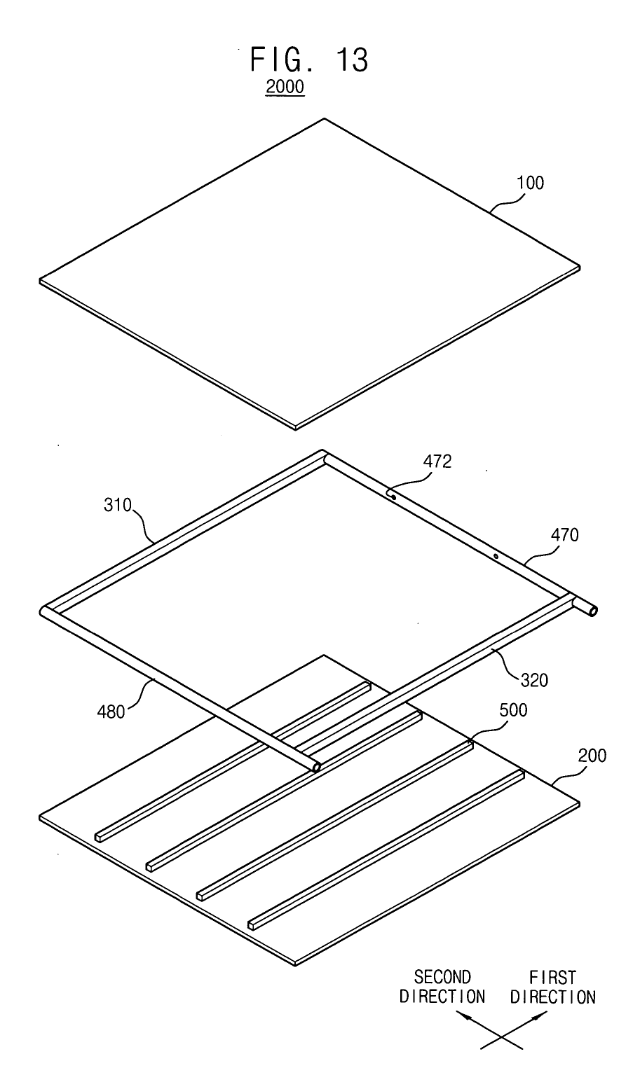

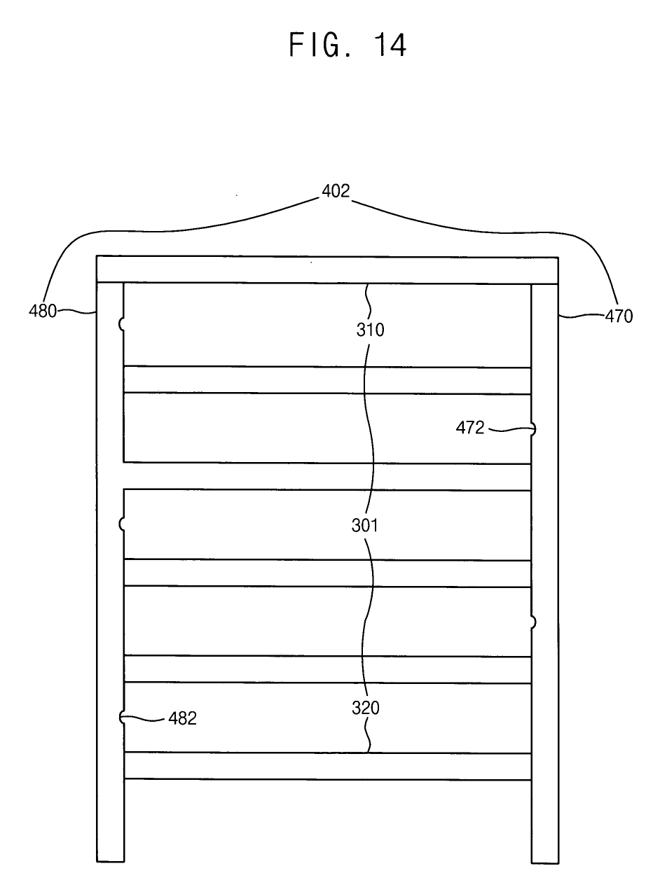

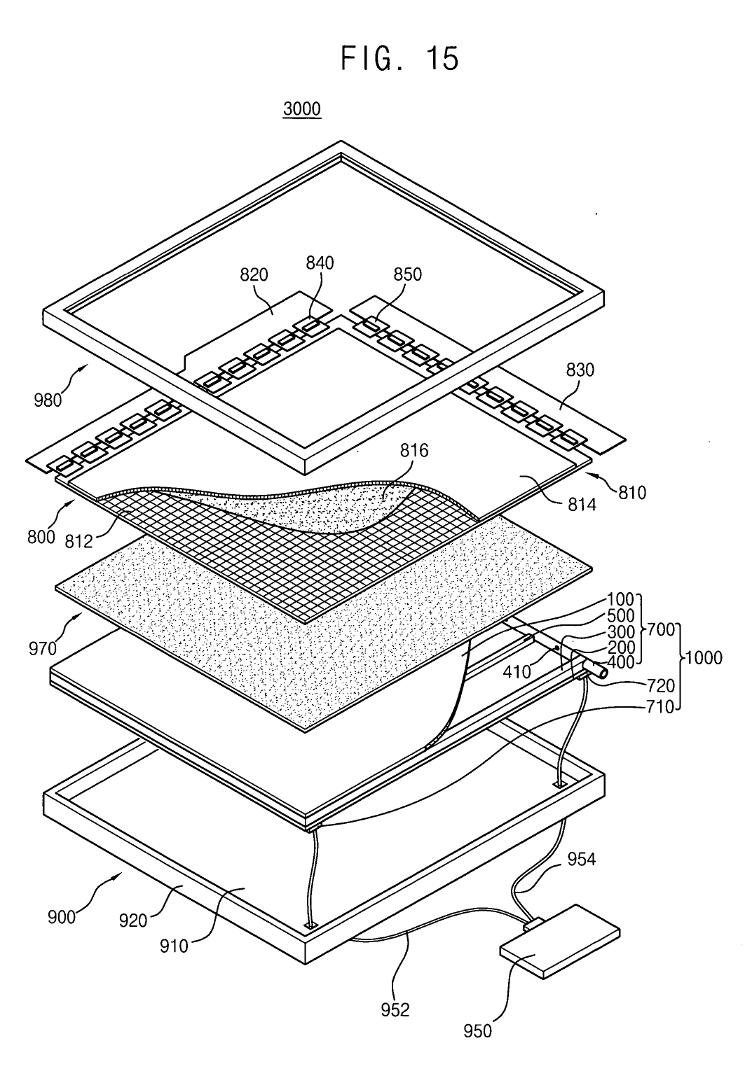

FIG. 13 is an exploded perspective view showing a planar light source in accordance with another exemplary embodiment of the present invention. FIG. 14 is a plan view showing the planar light source shown in FIG. 13. The planar light source shown in FIG. 13 is same as shown in FIGS. 2 to 5 with the exception of a supporting member and a connecting member. Thus, the same reference numerals will be used to refer to the same or like parts as those described in FIGS. 2 to 5 and any further explanation will be omitted.

Referring to FIGS. 13 and 14, the planar light source 2000 includes a first substrate 100, a second substrate 200, a supporting member 301, a connecting member 402 and a space dividing member 500. In this embodiment, the planar light source 2000 includes a plurality of the space dividing members 500. The first substrate 100 is disposed opposing the second substrate 200. The supporting member 301 is disposed between the first and second substrates 100 and 200. The connecting member 402 is disposed between the first and second substrates 100 and 200.

The supporting member 301 includes a first sidewall 310 and a second sidewall 320 spaced apart from the first sidewall 310. The first sidewall 310 is is disposed substantially parallel to the second sidewall 320. The first and second sidewalls 310 and 320 each have a first end and a second end. Each space dividing member 500 is substantially parallel to the first and second sidewalls 310 and 320. The first and second sidewalls 310 and 320 and each space dividing member 500 are extended in a first direction.

The connecting member 402 includes a first connecting tube 470 and a second connecting tube 480. The first and second connecting tubes 470 and 480 each have a first end and a second end. The first end of the first connecting tube 470 is connected to the first end of the first sidewall 310. The second end of the first connecting tube 470 is connected to the first end of the second sidewall 320. The first end of the second connecting tube 480 is connected to the second end of the first sidewall 310. The second end of the second connecting tube 480 is connected to the second end of the second sidewall 320. The first connecting tube 470 is substantially parallel to the second connecting tube 480. The first and second connecting tubes 470 and 480 are substantially perpendicular to the first and second sidewalls 310 and 320. The first and second connecting tubes 470 and 480 are also substantially perpendicular to each space dividing member 500. The first and second connecting tubes 470 and 480 are extended in a second direction that is substantially perpendicular to the first direction. The first and second substrates 100 and 200, the first and second sidewalls 310 and 320, and the first and second connecting tubes 450 and 460 are assembled as described above so as to define the discharge space. The discharge space may be closed.

The first and second connecting tubes 470 and 480 have the circular cross-sections similar to the connecting member 400 as shown in FIG. 5. Alternatively, the first and second connecting tubes 470 and 480 may have the rectangular cross-sections similar to the connecting member 600 as shown in FIG. 6.

The first connecting tube 470 includes one or more first orifices 472, and the second connecting tube 480 includes one or more second orifices 482. The discharge portions are numbered sequentially from the discharge portion closest to the first sidewall 310 to the discharge portion closest to the second sidewall 320. The first orifices 472 of the first connecting tube 470 correspond to even numbered discharge portions of the discharge space. The second orifices 482 of the second connecting tube 480 correspond to odd numbered discharge portions of the discharge space. Therefore, the discharge portions of the discharge space are alternately connected to one another through the first connecting tube 470 having the first orifices 472 and the second connecting tube 480 having the second orifices 482.

According to this exemplary embodiment, the discharge portions are alternately connected to one another so as to prevent a rapid movement of plasma formed by a discharge gas, thereby uniformizing a luminance of the light provided by the planar light source 2000.

FIG. 15 is an exploded perspective view showing a liquid crystal display (LCD) apparatus in accordance with an exemplary embodiment of the present invention. The LCD apparatus 3000 in FIG. 15 employs the planar light source in FIGS. 2 to 5. Thus, the same reference numerals will be used to refer to the same or like parts as those described in FIGS. 2 to 5 and any further explanation will be omitted. It should be noted that the LCD apparatus of the present invention may employ one of the above-described embodiments of the planar light source of the present invention and their equivalents.

Referring to FIG. 15, the LCD apparatus 3000 includes the planar light source 1000, a display unit 800 and a receiving container 900. The planar light source 1000 includes a lamp body 700 having a discharge space, a first electrode 710 and a second electrode 720. The first and second electrodes 710 and 720 are disposed on end portions of the lamp body 700.

The lamp body 700 includes a first substrate 100, a second substrate 200, a supporting member 300, a connecting member 400 and space dividing members 500. The second substrate 200 is spaced apart from the first substrate 100, and the second substrate 200 is disposed facing the first substrate 100. The supporting member 300 is disposed between the first and second substrates 100 and 200. The connecting member 400 is disposed between the first and second substrates 100 and 200.

The supporting member 300 is connected to the connecting member 400. The first substrate 100, the second substrate 200, the supporting member 300 and the connecting member 400 are structured to define a discharge space. The discharge space is preferably closed.

The connecting member 400 is extended in a direction that is substantially perpendicular to a longitudinal direction of the space dividing members 500. The connecting member 400 includes orifices 410. The discharge space is divided into discharge portions by the space dividing members 500. Each of the orifices 410 corresponds to each of the discharge portions of the discharge space.

The display unit 800 includes an LCD panel 810, a data printed circuit board (PCB) 820, and a gate PCB 830. The LCD panel 810 displays an image. The data and gate PCBs 820 and 830 generate driving signals to drive the LCD panel 810. The data and gate PCBs 820 and 830 are electrically connected to the LCD panel 810 through a data tape carrier package (TCP) 840 and a gate TCP 850. The LCD panel 810 includes a thin film transistor (TFT) substrate 812, a color filter substrate 814 and liquid crystal 816. The color filter substrate 814 is disposed facing the TFT substrate 812. The liquid crystal 816 is disposed between the TFT substrate 812 and the color filter substrate 814.

The TFT substrate 812 has a transparent glass plate, a pixel electrode and switching elements that are arranged in a matrix shape. Each switching element may be a TFT (not shown) formed on the transparent glass plate. A source electrode (not shown) of the TFT (not shown) is electrically connected to a data line. A gate electrode (not shown) of the TFT (not shown) is electrically connected to a gate line. A drain electrode (not shown) of the TFT (not shown) is electrically connected the pixel electrode (not shown).

The color filter substrate 814 includes a transparent plate, a color filter (not shown), a red color filter (not shown), a green color filter (not shown) and a blue color filter (not shown). The red, green and blue color filters (not shown) are formed on the transparent plate through a deposition process, a coating process or a photo process, etc. The common electrode (not shown) is formed on the transparent plate having the red, green and blue color filters (not shown). The common electrode (not shown) includes a transparent conductive material.

When voltages are applied to the gate and source electrodes of the TFT, the TFT is turned on so that an electric field is formed between the pixel electrode of the TFT substrate 812 and the common electrode of the color filter substrate 814. The liquid crystal 816, particularly arrangement of the liquid crystal molecules, varies in response to the electric field applied thereto, and thus light transmittance of the liquid crystal 816 also varies. The LCD panel 810 displays images using such optical properties of the liquid crystal 816.

The receiving container 900 includes a bottom plate 910 and side plates 920. The side plates 920 are each extended from an edge of the bottom plate 910 to form a receiving space. The planar light source 1000 and the LCD panel 810 are received in the receiving space.

A size of the bottom plate 910 is adjusted to fit for receiving the planar light source 1000. The bottom plate 910 may have a substantially identical shape to the planar light source 1000. In this exemplary embodiment, the bottom plate 910 and the planar light source 1000 have a rectangular shape. The side plates 920 are substantially perpendicular to the bottom plate 910. The side plates 920 make contact with four sides of the planar light source 1000 to prevent a drifting of the planar light source 1000.

The LCD apparatus 3000 further includes an inverter 950 for generating discharge voltages. The discharge voltages include a discharge start voltage and a discharge maintain voltage. The discharge voltages generated from the inverter 950 are applied to the planar light source 1000 through a first power supply line 952 and a second power supply line 954. The first power supply line 952 is electrically connected to the first electrode 710 of the planar light source 1000. The second power supply line 954 is electrically connected to the second electrode 720. Alternatively, the first and second power supply lines 952 and 954 may be electrically connected to the first and second electrodes 710 and 720 through a first connector and a second connector (not shown), respectively. The first connector is disposed between the first power supply line 952 and the first electrode 710, and the second connector is disposed between the second power supply line 954 and the second electrode 720.

The LCD apparatus 3000 further includes an optical sheet and a top chassis 980. In this exemplary embodiment, the LCD apparatus 3000 includes optical sheets 970 that are disposed between the planar light source 1000 and the LCD panel 810. When the light generated from the planar light source 1000 passes through the optical sheets 970, a luminance of the light is increased and the luminance of the light is also uniformized. The optical sheets 970 may include a diffusion sheet, a prism sheet, a brightness enhancement film, etc.

The top chassis 980 surrounds sides of the LCD panel 810, and the top chassis 980 is combined with the receiving container 900. The top chassis 980 protects the LCD panel 810 from an impact that is provided from an exterior to the LCD apparatus 3000. In addition, the top chassis 980 prevents a drifting of the LCD panel 810 from the receiving container 900.

According to the present invention, the connecting member is disposed on one side or more sides of the lamp body so that a thickness of the planar light source is decreased. End portions of each space dividing member are connected to the supporting member and the connecting member, respectively, so as to prevent a channeling that otherwise would be formed by a crosstalk between discharge portions of discharge space, thereby improving light emission characteristics of the planar light source.

Furthermore, a first electrode and a second electrode are overlapped with each space dividing member so that a distance between the first and second electrodes is increased, thereby increasing a size of an effective light emitting surface of the planar light source. Also, the connecting member includes a segmental wall having a throughhole. In addition, the discharge portions may be alternately connected to one another. Therefore, luminance of the planar light source is uniformized.

This invention has been described with reference to the exemplary embodiments. It is evident, however, that many alternative modifications and variations will be apparent to those having skill in the art in light of the foregoing description. Accordingly, the present invention embraces all such alternative modifications and variations as fall within the spirit and scope of the appended claims.

1. A planar light source comprising:
a first substrate;
a second substrate spaced apart from the first substrate;
a supporting member disposed between the first and second substrates;
a connecting member connected to the supporting member and disposed between the first and second substrates, the connecting member, the supporting member, and the first and second substrates being configured to define a discharge space; and
a connecting passage formed in the connecting member, the connecting passage providing a gas-flow path between the discharge space and an outside of the connecting member.

2. The planar light source of claim 1, wherein the planar light source includes an orifice formed at a selected position of the connecting member, the gas-flow path being formed through the connecting passage and the orifice.

3. The planar light source of claim 2, wherein air is exhausted from the discharge space to the outside of the connecting member and a discharge gas is injected into the discharge space via the connecting passage and the orifice.

4. The planar light source of claim 2, wherein the planar light source includes a plurality of orifices disposed at selected positions, respectively, of the connecting member, the gas-flow path being formed through the connecting passage and the plurality of orifices.

5. The planar light source of claim 1, further comprising a space dividing member between the first and second substrates to divide the discharge space into discharge portions.

6. The planar light source of claim 1, further comprising a plurality of space dividing members between the first and second substrates, and wherein each space dividing member is disposed substantially parallel to one another and divides the discharge space into discharge portions.

7. The planar light source of claim 5, wherein the space dividing member includes opposite end portions in a longitudinal direction of the space dividing member, one of opposite end portions being connected to the supporting member.

8. The planar light source of claim 7, wherein the other of the opposite end portions is connected to the connecting member.

9. The planar light source of claim 5, wherein the planar light source includes an orifice formed at a selected position of the connecting member, the orifice being disposed corresponding to at least one of the discharge positions.

10. The planar light source of claim 5, wherein the planar light source includes a plurality of orifices disposed at selected positions, respectively, of the connecting member, each orifice being disposed corresponding to each discharge portion.

11. The planar light source of claim 9, wherein the connecting member further comprises a segmental wall disposed inside the connecting member to divide the connecting passage into connecting segments, the segmental wall having a throughhole that connects the connecting segments to one another.

12. The planar light source of claim 1, wherein the supporting member comprises:
a first sidewall having opposite end portions in a longitudinal direction of the first sidewall;
a second sidewall spaced apart from the first sidewall, the second sidewall having opposite end portions in a longitudinal direction of the second sidewall; and
a third sidewall having opposite end portions in a longitudinal direction of the third sidewall, the opposite end portions of the third sidewall being connected to one opposite end portion of the first sidewall and one opposite end portion of the second sidewall, respectively.

13. The planar light source of claim 12, wherein the connecting member is connected to the other opposite end portion of the first sidewall and the other opposite end portion of the second sidewall.

14. The planar light source of claim 1, wherein the supporting member comprises:
a first sidewall having opposite end portions in a longitudinal direction of the first sidewall; and
a second sidewall spaced apart from the first sidewall, the second sidewall having opposite end portions in a longitudinal direction of the first sidewall.

15. The planar light source of claim 14, wherein the connecting member comprises:
a first connecting tube having a first end portion and a second end portion, the first end portion of the first connecting tube being connected to one opposite end portion of the first sidewall, the second end portion of the first connecting tube being connected to one opposite end portion of the second sidewall; and
a second connecting tube having a first end portion and a second end portion, the first end portion of the second connecting tube being connected to the other opposite end portion of the first sidewall, the second end portion of the second connecting tube being connected to the other opposite end portion of the second sidewall.

16. The planar light source of claim 15, wherein the first connecting tube and the second connecting tube are disposed substantially parallel to each other.

17. The planar light source of claim 15, wherein the first connecting tube includes a first orifice disposed at a selected position of the first connecting tube and the second connecting tube includes a second orifice disposed at a selected position of the second connecting tube, air is exhausted from the discharge space and discharge gas is injected into the discharge space through the first and second orifices.

18. The planar light source of claim 15, further comprising a space dividing member between the first and second substrates to divide the discharge space into discharge portions, wherein the first connecting tube includes first orifices each of which is disposed corresponding to each discharge portion and the second connecting tube includes second orifices each of which is disposed corresponding to each discharge portion.

19. The planar light source of claim 15, further comprising a space dividing member between the first and second substrates to divide the discharge space into discharge portions, wherein the first connecting tube includes first orifices and the second connecting tube includes second orifices, the first and second orifices are alternately arranged with respect to the discharge portions such that one first orifice corresponds to every other discharge portion and one second orifice corresponds to every discharge portion not connected to a first orifice.

20. The planar light source of claim 5, further comprising a first electrode and a second electrode spaced apart from the first electrode, wherein the first and second electrodes are extended in a direction that is substantially perpendicular to a longitudinal direction of the space dividing member.

21. The planar light source of claim 20, wherein the first and second electrodes are disposed on opposite edge portions of an outer surface of the second substrate, and the first and second electrodes are overlapped with the space dividing member.

22. A liquid crystal display apparatus comprising:
a planar light source including a lamp body having a discharge space and a connecting member, the connecting member having a cavity extending along an interior portion of the connecting member, the cavity allowing gas to flow into and from the discharge space through the connecting member;
a liquid crystal display panel displaying an image using light generated from the planar light source; and
a receiving container receiving the planar light source and the liquid crystal display panel.

23. The liquid crystal display apparatus of claim 22, wherein the lamp body further comprises:
a first substrate;
a second substrate spaced apart from the first substrate;
a supporting member disposed between the first and second substrates, the supporting member connected to the connecting member, the first and second substrates and the supporting and connecting members being configured to define the discharge space; and
space dividing members disposed between the first and second substrates substantially parallel to each other to divide the discharge space into discharge portions.

24. The liquid crystal display apparatus of claim 23, wherein the connecting member is disposed in a direction that is substantially perpendicular to a longitudinal direction of the space dividing members.

25. The liquid crystal display apparatus of claim 24, wherein the connecting member has orifices each of which is disposed corresponding to each discharge portion.

26. The liquid crystal display apparatus of claim 23, wherein each space dividing member includes two opposite end portions in a longitudinal direction, the two opposite end portions being connected to the supporting member and the connecting member, respectively.

27. The liquid crystal display apparatus of claim 23, wherein the planar light source further comprises a first electrode and a second electrode spaced apart from the first electrode, wherein the first and second electrodes are extended in a direction that is substantially perpendicular to a longitudinal direction of the space dividing members.

28. The liquid crystal display apparatus of claim 27, wherein the first and second electrodes are disposed on opposite edge portions of an outer surface of the planar light source, and the first and second electrodes are overlapped with each space dividing member.

29. The liquid crystal display apparatus of claim 27, further comprising an inverter for applying a discharge voltage to the first and second electrodes.
